(19) United States
(12) Patent Application Publication
(10) Pub. No.: US 2014/0189891 A1
(43) Pub. Date: Jul. 3, 2014

(54) HARD DISK ASSEMBLY AND ELECTRONIC DEVICE USING SAME

(71) Applicants: HON HAI PRECISION INDUSTRY CO., LTD., New Taipei (TW); HONG FU JIN PRECISION INDUSTRY (Shenzhen) CO., LTD, Shenzhen (CN)

(72) Inventors: KANG WU, Shenzhen (CN); BO TIAN, Shenzhen (CN)

(73) Assignees: HON HAI PRECISION INDUSTRY CO., LTD., New Taipei (TW); HONG FU JIN PRECISION INDUSTRY (Shenzhen) CO., LTD, Shenzhen (CN)

(21) Appl. No.: 14/140,623

(22) Filed: Dec. 26, 2013

(30) Foreign Application Priority Data
Dec. 27, 2012 (CN) 2012105775002

(51) Int. Cl. G06F 21/88

(52) U.S. Cl. CPC G06F 21/88
USPC 726/35

(57) ABSTRACT

A hard disk assembly includes a frame, a hard disk, and a lock device. The hard disk is assembled in the frame. The lock device is located in the frame. The hard disk assembly is installed in an electronic device. The electronic device includes a support. The frame is slidably installed in the support. The lock device stores a predetermined password and receives a password inputted by a user. The lock device unlocks the hard disk assembly from the support if the password inputted by the user matches the predetermined password.

### BACKGROUND

1. Technical Field

The disclosure generally relates to hard disk technologies, and more particularly to a hard disk assembly and an electronic device using the hard disk assembly.

2. Description of Related Art

Generally, a hard disk is fastened to a frame of an electronic device by fasteners. Thus, the hard disk is easily stolen by unscrewing the fasteners.

Therefore, it is desirable to provide a means to overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an exploded, isometric view of an embodiment of an electronic device.

FIG. 2 is an assembled, isometric view of the electronic device of FIG. 1.

FIG. 3 is a functional block diagram of an embodiment of a lock device in FIG. 1.

FIG. 4 is a schematic view of an input unit and a display unit in FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

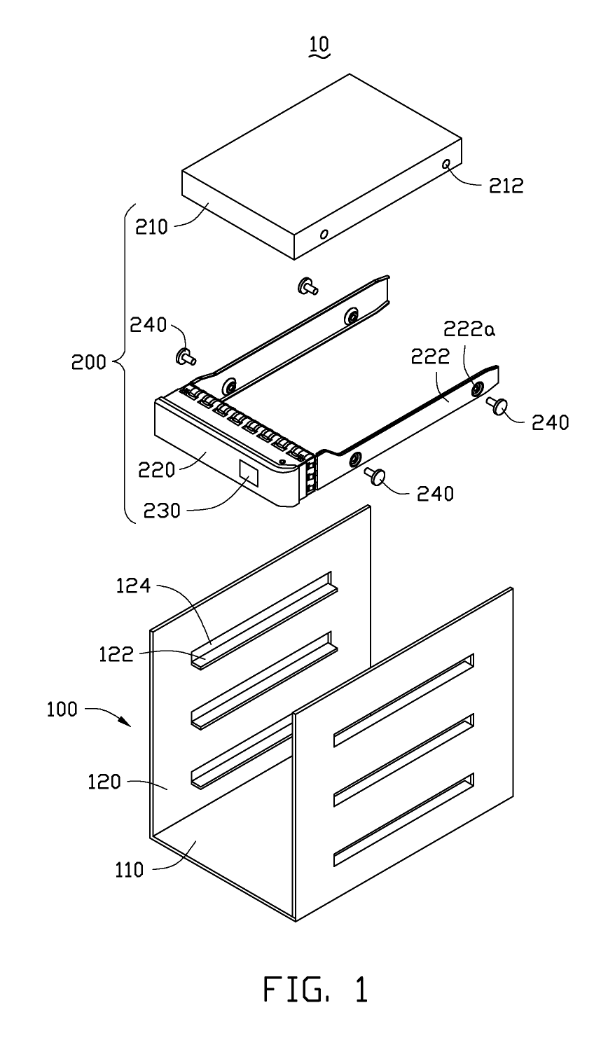

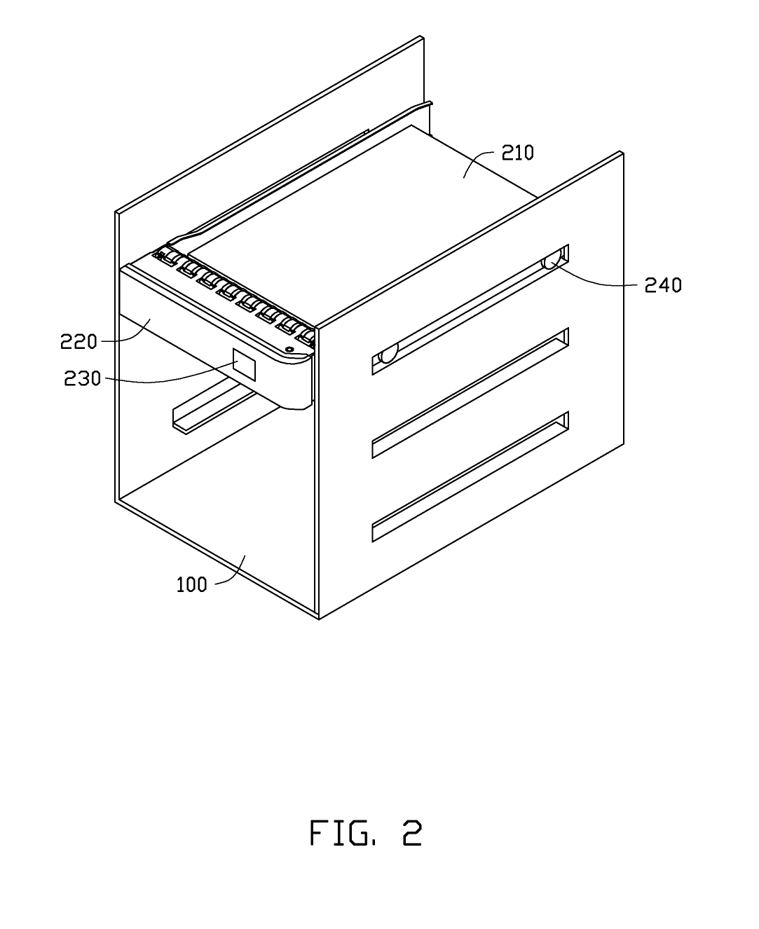

FIG. 1 and FIG. 2 show an exemplary embodiment of an electronic device 10. The electronic device 10 includes a support 100 and a hard disk assembly 200 positioned in the support 100. The electronic device 10 can be, but is not limited to, a server, a computer case, or other equipment using a hard disk to store data. In the illustrated embodiment, the electronic device 10 is a server.

The support 100 includes a bridge 110 and a pair of sidewalls 120. The sidewalls 120 are substantially parallel to each other and extend substantially perpendicularly from respective opposite sides of the bridge 110. Each of the sidewalls 120 includes at least one supporting board 122 and defines at least one slot 124 corresponding to the supporting board 122. In the illustrated embodiment, each sidewall 120 includes three supporting boards 122 and three slots 124.

The hard disk assembly 200 includes a hard disk 210, a frame 220, a lock device 230, and a number of fasteners 240. In one embodiment, the fasteners 240 are made of metal.

The hard disk 210 includes a pair of substantially parallel sidewalls and defines at least one fastening hole 212 in each of the sidewalls. In the illustrated embodiment, each sidewall defines two fastening holes 212.

The frame 220 includes a pair of substantially parallel supporting arms 222. The pair of supporting arms 222 extends from respective opposite sides of the frame 220. Each of the supporting arms 222 defines at least one fastening through hole 222a. In the illustrated embodiment, each supporting arm 222 defines two fastening through holes 222a. The fastening through holes 222a of the supporting arms 222 correspond to the fastening holes 212 of the hard disk 210.

In assembly of the electronic device 10, the hard disk 210 is assembled between the pair of supporting arms 222 of the frame 220. The frame 220 is slidably installed in the support 100, such that the pair of supporting arms 222 is supported by a corresponding pair of supporting boards 122. The fasteners 240 are received the corresponding slot 124, the corresponding fastening through holes 222a, and the corresponding fastening holes 212, thereby fixing the hard disk 210 in the frame 220, and fixing the frame 220 in the support 100.

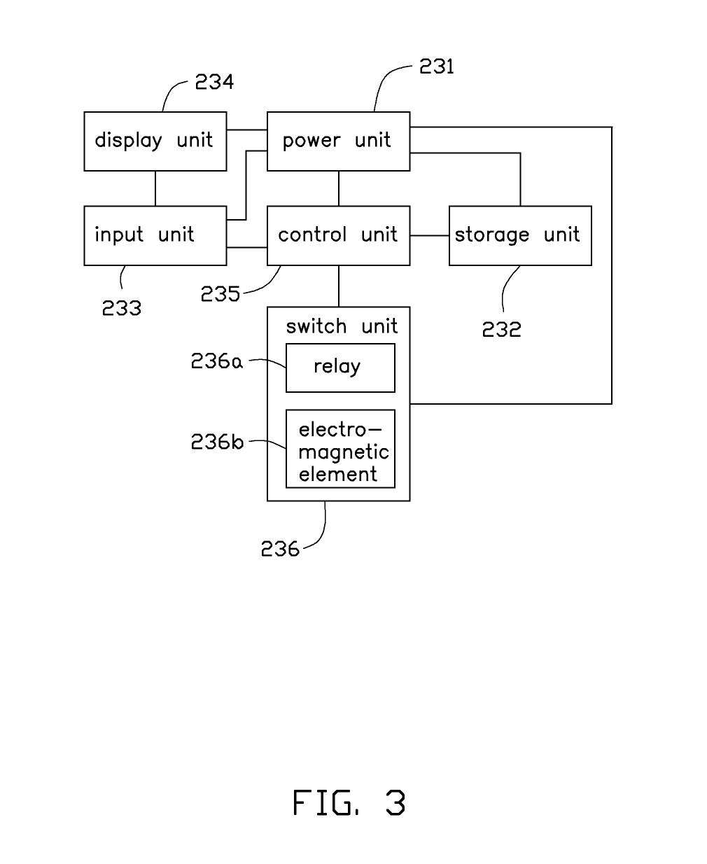

The lock device 230 is located inside the frame 220. FIG. 3 shows a functional block diagram of the lock device 230. The lock device 230 includes a power unit 231, a storage unit 232, an input unit 233, a display unit 234, a control unit 235, and a switch unit 236.

The power unit 231 is electronically connected to and provides electrical power to the storage unit 232, the input unit 233, the display unit 234, the control unit 235, and the switch unit 236. In one embodiment, the power unit 231 is a battery.

The storage unit 232 is connected to the control unit 235 and stores a predetermined password. The storage unit 232 can be, but is not limited to, an electrically programmable read-only-memory (EPROM), an electrically erasable programmable read-only-memory (EEPROM) or a flash read-only-memory (flash ROM).

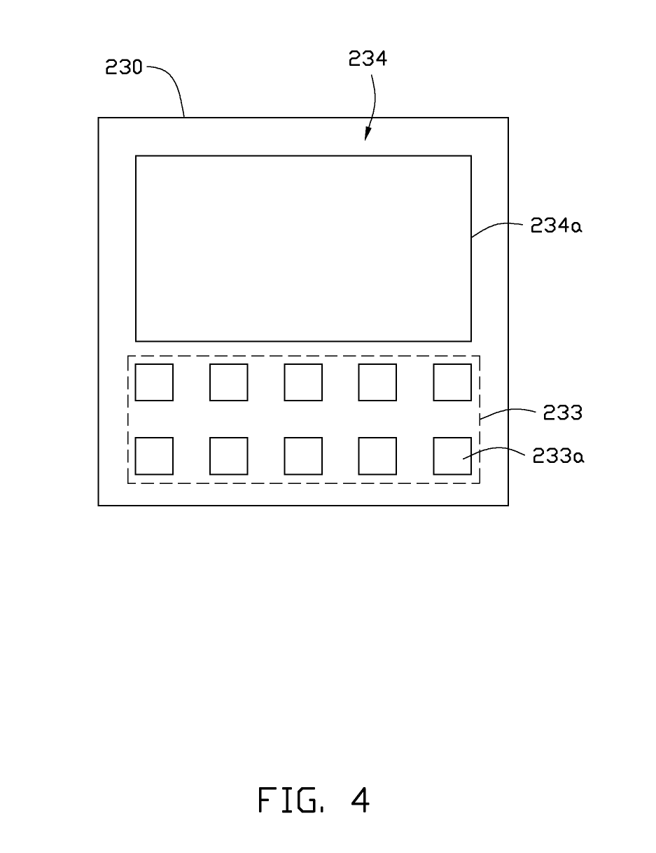

The input unit 233 is connected to the control unit 235 and receives a password inputted by a user. In FIG. 4, in the illustrated embodiment, the input unit 233 includes a number of keys 233a for inputting the password.

The display unit 234 is connected to the input unit 233 and displays images. In one embodiment, the display unit 234 includes a screen 234a for displaying the password inputted by the user.

The control unit 235 compares the inputted password with the predetermined password, and transmits a closing signal to the switch unit 236 if the inputted password is different from the predetermined password, or transmits an opening signal to the switch unit 236 if the inputted password matches the predetermined password.

The switch unit 236 is connected to the control unit 235. The switch unit 236 locks the hard disk assembly 220 in the support 100 according to the closing signal, or unlocks the hard disk assembly 200 from the support 100 according to the opening signal.

In the illustrated embodiment, the switch unit 236 includes a relay 236a, and a number of electromagnetic elements 236b corresponding to the fastening through holes 222a. The relay 236 stays energized when the inputted password is a wrong password different from the predetermined password, and is cut off when the inputted password is a correct password matching the predetermined password. When the relay 236a stays energized, the electromagnetic elements 236b are magnetic and attract the fasteners 240. When the relay 236 is cut off, the electromagnetic elements 236b are demagnetized.

If a user inputs a wrong password different from the predetermined password, the control unit 235 transmits the closing signal to the switch unit 236, the relay 236a stays energized, and the electromagnetic elements 236b attract the fasteners 240 to stay locked in the fastening through holes 222a and the fastening holes 212, to lock the hard disk assembly 200 in the support 100.

If a user inputs a correct password matching the predetermined password, the control unit 235 transmits the opening signal to the switch unit 236, which cuts off the relay 236a. Thus, the electromagnetic elements 236b are demagnetized, and the fasteners 240 can be removed easily to remove the hard disk assembly 200 from the support 100.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A hard disk assembly comprising:
a frame,
a hard disk assembled in the frame, and
a lock device located inside the frame,
the hard disk assembly is slidably installed in a support of the electronic device, the lock device stores a predetermined password, receives a password inputted by a user, locks the hard disk assembly to the support, and unlocks the hard disk assembly from the support while the inputted password matches the predetermined password.

2. The hard disk assembly of claim 1, wherein the lock device comprises a power unit, a storage unit, an input unit, a control unit, and a switch unit,
the power unit is electronically connected to and provides electrical power to the storage unit, the input unit, the control unit and the switch unit;
the storage unit is connected to the control unit and stores a predetermined password;
the input unit is connected to the control unit and receives a password inputted by a user;
the control unit compares the inputted password with the predetermined password, and transmits a closing signal to the switch unit if the inputted password is different from the predetermined password, and transmits an opening signal to the switch unit if the inputted password matches the predetermined password; and
the switch unit is connected to the control unit, and locks the hard disk assembly in the support according to the closing signal, and unlocks the hard disk assembly from the support according to the opening signal.

3. The hard disk assembly of claim 2, wherein the hard disk assembly further comprises a display unit, the power unit is further connected to and provides electrical power to the display unit, the display unit is connected to the input unit, and comprises a screen for displaying the password inputted by the user.

4. The hard disk assembly of claim 2, wherein the hard disk assembly further comprises a number of fasteners, the hard disk comprises a pair of substantially parallel sidewalls and defines at least one fastening hole in each of the sidewalls, the frame comprises a pair of substantially parallel supporting arms extending from respective opposite sides of the frame, each of the supporting arms defines at least one fastening through hole, the fastening through holes of the supporting arms correspond to the fastening holes of the hard disk, the fasteners are received the support, the corresponding fastening through holes, and the corresponding fastening holes, thereby fixing the hard disk in the frame, and fixing the frame in the support.

5. The hard disk assembly of claim 4, wherein the switch unit comprises a relay, and a number of electromagnetic elements corresponding to the fastening through holes, the relay magnetizes the electromagnetic elements to attract the fasteners to stay locked in the fastening through holes and fastening holes, to lock the hard disk assembly in the support, the control unit transmits the opening signal to the switch unit to cut off the relay, and the electromagnetic elements are demagnetized, and the fasteners can be removed easily to remove the hard disk assembly from the support.

6. The hard disk assembly of claim 4, wherein the support comprises a bridge and a pair of sidewalls, the sidewalls are substantially parallel to each other and substantially perpendicularly from respective opposite sides of the bridge, each of the sidewalls comprises at least one supporting board and defines at least one slot corresponding to the supporting board.

7. The hard disk assembly of claim 6, wherein the hard disk is assembled between the pair of supporting arms of the frame in assembly of the electronic device, the pair of supporting arms is supported by a corresponding pair of supporting boards.

8. The hard disk assembly of claim 4, wherein the fasteners are made of metal.

9. An electronic device comprising:
A hard disk assembly and a support, the hard disk assembly comprises a frame, a hard disk assembled in the frame, and a lock device located inside the frame, the frame is slidably installed in the support, the lock device stores a predetermined password, receives a password inputted by a user, locks the hard disk assembly to the support, and unlocks the hard disk assembly from the support while the inputted password matches the predetermined password.

10. The electronic device of claim 9, wherein the lock device comprises a power unit, a storage unit, an input unit, a control unit, and a switch unit,
the power unit is electronically connected to and provides electrical power to the storage unit, the input unit, the control unit and the switch unit;
the storage unit is connected to the control unit and stores a predetermined password;
the input unit is connected to the control unit and receives a password inputted by a user;
the control unit compares the inputted password with the predetermined password, and transmits a closing signal to the switch unit if the inputted password is different from the predetermined password, and transmits an opening signal to the switch unit if the inputted password matches the predetermined password; and
the switch unit is connected to the control unit, and locks the hard disk assembly in the support according to the closing signal, and unlocks the hard disk assembly from the support according to the opening signal.

11. The electronic device of claim 10, wherein the hard disk assembly further comprises a display unit, the power unit is further connected to and provides electrical power to the display unit, the display unit is connected to the input unit, and comprises a screen for displaying the password inputted by the user.

12. The electronic device of claim 10, wherein the hard disk assembly further comprises a number of fasteners, the hard disk comprises a pair of substantially parallel sidewalls and defines at least one fastening hole in each of the sidewalls, the frame comprises a pair of substantially parallel supporting arms extending from respective opposite sides of the frame, each of the supporting arms defines at least one fastening through hole, the fastening through holes of the supporting arms correspond to the fastening holes of the hard disk, the fasteners are received the support, the corresponding fastening through holes, and the corresponding fastening holes, thereby fixing the hard disk in the frame, and fixing the frame in the support.

13. The electronic device of claim 12, wherein the switch unit comprises a relay, and a number of electromagnetic elements corresponding to the fastening through holes, the relay magnetizes the electromagnetic elements to attract the fasteners to stay locked in the fastening through holes and fastening holes, to lock the hard disk assembly in the support, the control unit transmits the opening signal to the switch unit to cut off the relay, and the electromagnetic elements are demagnetized, and the fasteners can be removed easily to remove the hard disk assembly from the support.

14. The electronic device of claim 12, wherein the support comprises a bridge and a pair of sidewalls, the sidewalls are substantially parallel to each other and substantially perpendicularly from respective opposite sides of the bridge, each of the sidewalls comprises at least one supporting board and defines at least one slot corresponding to the supporting board.

15. The electronic device of claim 14, wherein the hard disk is assembled between the pair of supporting arms of the frame in assembly of the electronic device, the pair of supporting arms is supported by a corresponding pair of supporting boards.

16. The electronic device of claim 12, wherein the fasteners are made of metal.
